(19) United States
(12) Patent Application Publication
(10) Pub. No.: US 2014/0221887 A1
(43) Pub. Date: Aug. 7, 2014

(54) POSITIONING STRUCTURE OF PLASTIC DISK OF MASSAGING DEVICE

(71) Applicant: Dong-Her Wu, Changhua (TW)

(72) Inventor: Dong-Her Wu, Changhua (TW)

(21) Appl. No.: 14/164,120

(22) Filed: Jan. 24, 2014

(30) Foreign Application Priority Data
Feb. 7, 2013 (TW) 102104950

(51) Int. Cl. A61H 15/00

(52) U.S. Cl. CPC A61H 15/0092
USPC 601/112

(57) ABSTRACT

A positioning structure of a plastic disk in a massaging device may include a massaging unit, a connecting unit and a locking unit. The massaging unit has a protruding block that has a through hole. One end of the connecting unit has a receiving space that is used to receive the protruding block, a fixed hole of the connecting unit aligned with the through hole, and a plurality of positioning slots circularly formed at outer periphery of the fixed hole of the connecting unit. The locking unit has a head portion and a tubular unit extending from the head portion, wherein the tubular unit of the locking unit passes through the through hole and fixed hole, and a screw is used to secure the tubular unit to connect the massaging unit and the connecting unit.

### FIELD OF THE INVENTION

The present invention relates to a massaging device, more particularly to a positioning structure of plastic disk in the massaging device.

### BACKGROUND OF THE INVENTION

Conventional massaging devices, such as the one disclosing in Taiwanese Patent No.: M362693, titled “eccentrically rotated massaging device,” has an inner curved lip-shaped edge at an opening of a massaging cover, and the lip-shaped edge is used to touch the user's body with its resilience to increase the massaging area and further provide a comfortable massaging process. However, the conventional massaging device is disadvantageous because (i) the massaging cover is connected with a connecting unit and a rotating plate that has a polygonal hole. The rotating unit is driven by a motor with a shaft that is configured to plug into the polygonal hole. Although it results a quick assembly and disassembly, the connection between the massaging cover and the rotating unit may be too tight if the polygonal hole is too small, while the massaging cover may fall off if the polygonal hole is too large; (ii) the massaging cover has a ladder-shaped hole and the driving unit has a through hole, and a securing unit is used to pass through the ladder-shaped hole and through hole. When the massaging cover is conducting massaging activities, the massaging cover may generate a lateral force to the driving unit, so the securing unit may not be securely engaged with the driving unit; and (iii) since the rotating unit is connected with the massaging cover only through the shaft's insertion into the polygonal hole, when the massaging cover is conducting massaging activities, a lateral force is generated to the shaft to break the driving unit and further increase the wear inside the rotating unit. Therefore, there remains a need for a new and improved positioning structure in the massaging device to overcome the problems stated above.

### SUMMARY OF THE INVENTION

To solve the problems stated above, the present invention provides a positioning structure of a plastic disk in a massaging device may include a massaging unit, a connecting unit and a locking unit. The massaging unit has a protruding block that has a through hole. A bowl-shaped portion is formed at one end of the protruding block and an elastic ring is formed at an enlarging end of the bowl-shaped portion. An inner recessed slot is formed at outer periphery of the through hole of the bowl-shaped portion. One end of the connecting unit has a receiving space that is used to receive the protruding block of the massaging unit. The connecting unit has a fixed hole aligned with the through hole, and a plurality of positioning slots are circularly formed at outer periphery of the fixed hole of the connecting unit. A guiding inclined surface is formed inside the receiving space of the connecting unit and the guiding inclined surface is used to tightly attach with the massaging unit. The locking unit has a head portion and a tubular unit extending therefrom. The tubular unit of the locking unit passes through the through hole and fixed hole, and the head portion of the locking unit can be received in the inner recessed slot of the massaging unit to form a elastic compression to achieve an anti-leaking effect between the massaging unit and the locking unit. A screw is used to secure the tubular unit to connect the massaging unit and the connecting unit. Also, the connecting unit has a cover near the fixed hole, and top portion of the cover has a flat portion to cover the opening of the fixed hole to protect the screw therein.

The present invention further includes a driving device having a rotating shaft, and rear end of the rotating shaft has a plurality of positioning pieces, and a stopping block is protrudingly formed at outer surface of the positioning piece. The positioning piece of the driving device is used to plug into the positioning slot of the connecting unit, and the stopping block is received by the receiving space of the connecting unit to quickly engage the driving device and the massaging unit. When the massaging unit needs to be replaced, the connecting unit can be pulled to cause the positioning piece to shrink inwardly, so the massaging unit can be easily replaced. Also, a ring slot is recessedly formed at outer periphery of the positioning slot of the connecting unit and a restricting ring is protrudingly formed at outer periphery of the rotating shaft at a eccentric plate. The restricting ring is configured to plug into the ring slot of the connecting unit to prevent the connecting unit from overly bending the positioning piece.

The main objective of the present invention is that one end of the connecting unit has a receiving space that is used to receive the protruding block of the massaging unit, and the connecting unit has a fixed hole aligned with the through hole, and a plurality of positioning slots are circularly formed at outer periphery of the fixed hole of the connecting unit; the positioning piece of the driving device is used to plug into the positioning slot of the connecting unit, and the stopping block is received by the receiving space of the connecting unit to quickly engage the driving device and the massaging unit.

The second objective of the present invention is that the receiving space that is used to receive the protruding block of the massaging unit, and the connecting unit has a fixed hole aligned with the through hole, so that the head portion of the locking unit can be squeezed into the inner recessed slot of the massaging unit, and the screw can be inserted into the fixed hole of the connecting unit to secure the massaging unit and the connecting unit, and prevent the massaging unit and the connecting unit from falling off.

The third objective of the present invention is that the ring slot is recessedly formed at outer periphery of the positioning slot of the connecting unit and a restricting ring is protrudingly formed at outer periphery of the rotating shaft at a eccentric plate; the restricting ring is configured to plug into the ring slot of the connecting unit to prevent the connecting unit from overly bending the positioning piece.

### BRIEF DESCRIPTION OF THE DRAWINGS

FIG. 1 illustrates a three-dimensional view of the present invention.

FIG. 2 illustrates a first three-dimensional exploded view of the present invention.

FIG. 3 illustrates a second three-dimensional exploded view of the present invention.

FIG. 4 illustrates a sectional view in the present invention.

FIG. 5 illustrates a three-dimensional exploded view of the driving device in the present invention.

FIG. 6 illustrates a three-dimensional view of the driving device in the present invention.

FIG. 7 illustrates a partially sectional view of the driving device in the present invention.

FIG. 8 illustrates a schematic view of the driving device in the present invention when the driving device is in use.

FIG. 9 illustrates a schematic view of replacing the massaging unit in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

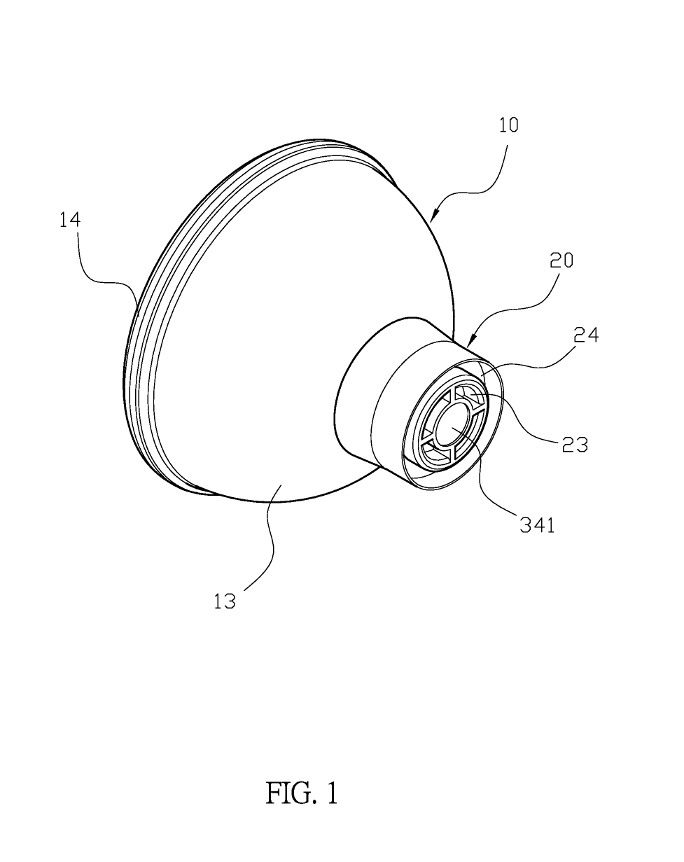

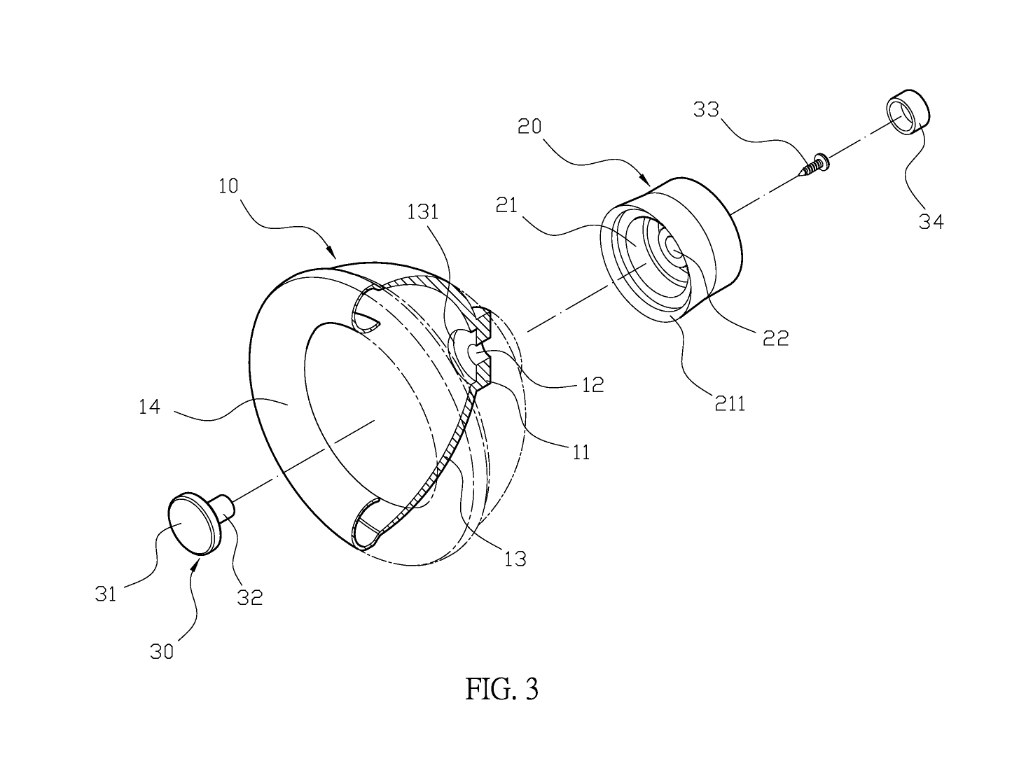

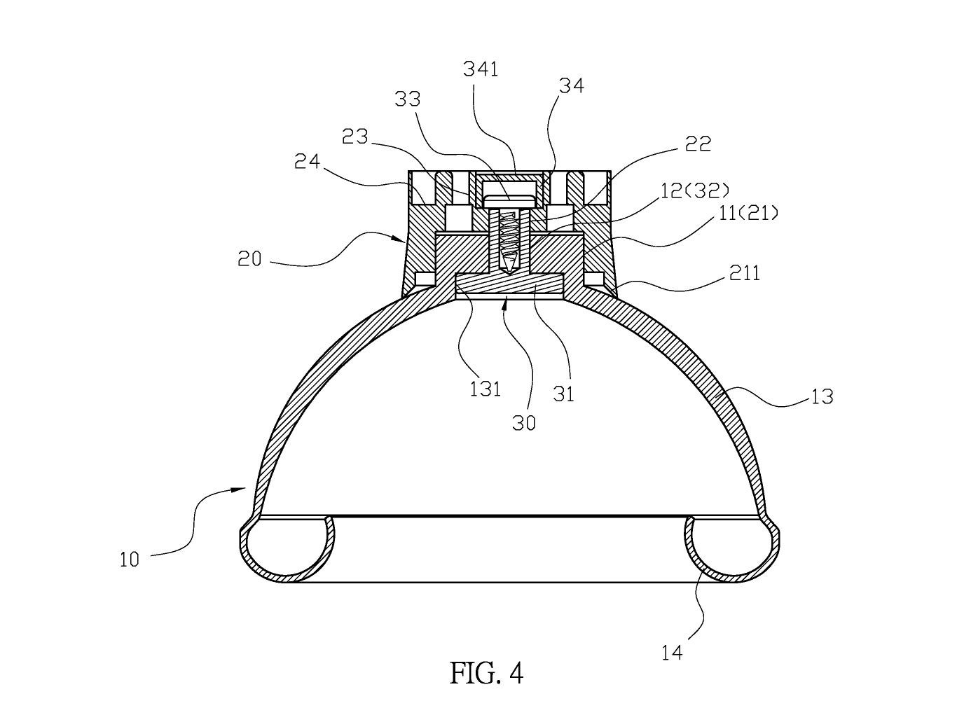

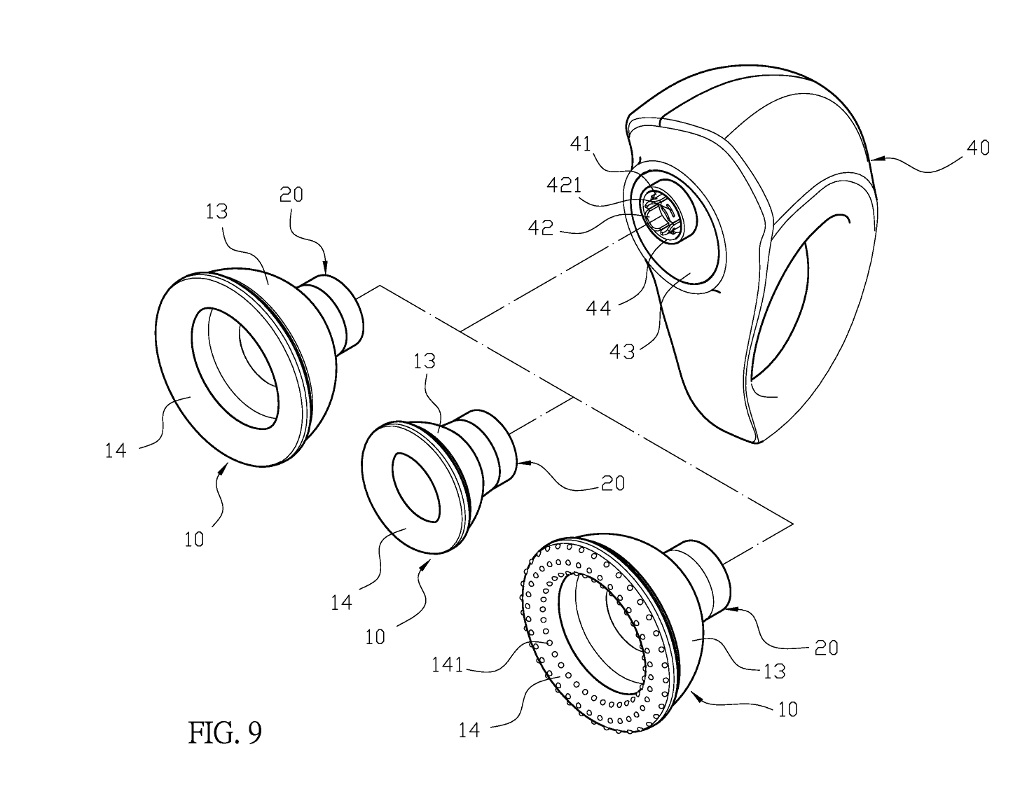

Referring to FIGS. 1 to 4, a positioning structure of a plastic disk in a massaging device may include a massaging unit 10, a connecting unit 20 and a locking unit 30. The massaging unit 10 has a protruding block 11 that has a through hole 12. A bowl-shaped portion 13 is formed at one end of the protruding block 11 and an elastic ring 14 is formed at an enlarging end of the bowl-shaped portion 13. An inner recessed slot 131 is formed at outer periphery of the through hole 12 of the bowl-shaped portion 13. One end of the connecting unit 20 has a receiving space 21 that is used to receive the protruding block 11 of the massaging unit 10. The connecting unit 20 has a fixed hole 22 aligned with the through hole 12, and a plurality of positioning slots 23 are circularly formed at outer periphery of the fixed hole 22 of the connecting unit 20. A guiding inclined surface 211 is formed inside the receiving space 21 of the connecting unit 20 and the guiding inclined surface 211 is used to tightly attach with the massaging unit 10. The locking unit 30 has a head portion 31 and a tubular unit 32 extending therefrom. The tubular unit 32 of the locking unit 30 passes through the through hole 12 and fixed hole 22, and the head portion 31 of the locking unit 30 can be received in the inner recessed slot 131 of the massaging unit 10 to form a elastic compression to achieve an anti-leaking effect between the massaging unit 10 and the locking unit 30. A screw 33 is used to secure the tubular unit 32 to connect the massaging unit 10 and the connecting unit 30. Also, the connecting unit 30 has a cover 34 near the fixed hole 22, and top portion of the cover 34 has a flat portion 341 to cover the opening of the fixed hole 22 to protect the screw 33 therein. Also referring to FIG. 9, the bowl-shaped portion 13 of the massaging unit 10 has various sizes that can all be used to secure the connecting unit 20 at the protruding block 11 to achieve the goal of quick replacement and connection. Furthermore, the production costs can be reduced because the connecting units 20 are of the same size. A plurality of protruding elements 141 are formed on the surface of the elastic ring 14 to enhance the massaging effect.

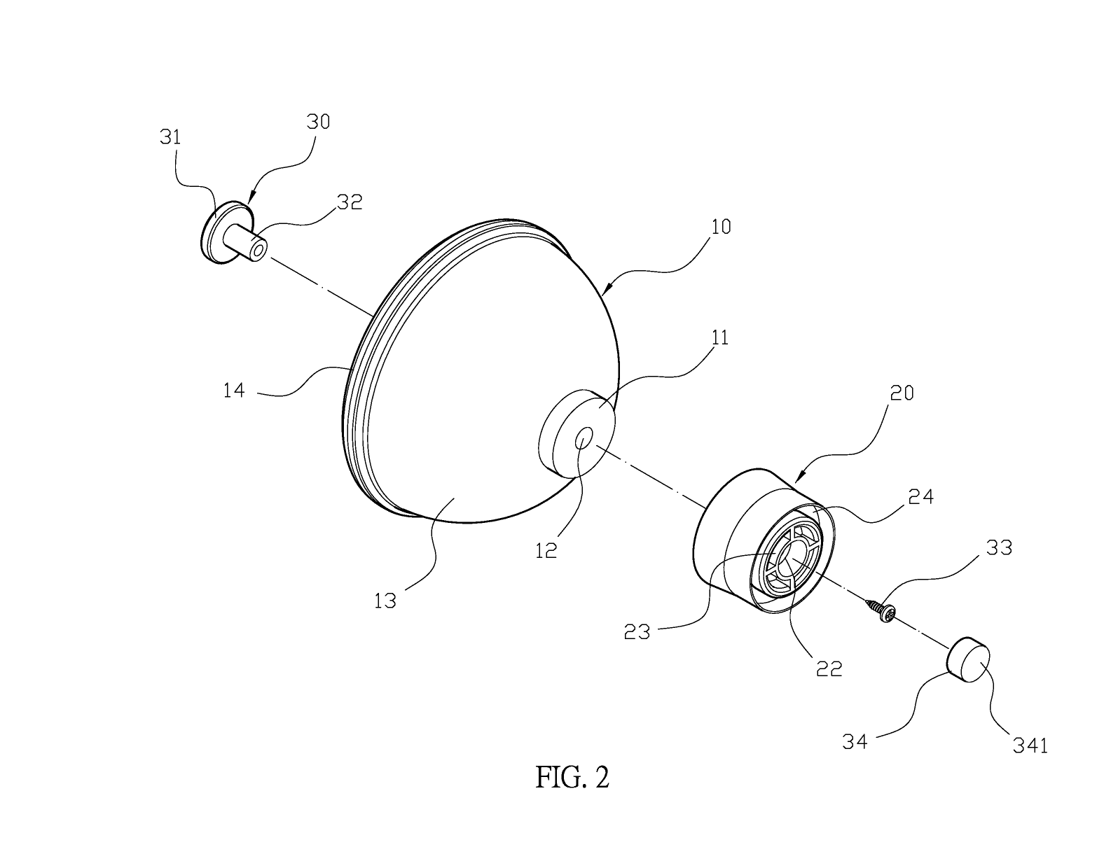

Referring to FIGS. 2 to 4 for the structure of the present invention, the receiving space 21 of the connecting unit 20 receives the protruding block 11 of the massaging unit 10, so that the fixed hole 22 can be aligned with the through hole 12 and the guiding inclined surface 211 of the connecting unit 20 attaches to the bowl-shaped portion 13 of the massaging unit 10. The tubular unit 32 of the locking unit 30 pass through the through hole 12 and fixed hole 22 from the bowl-shaped portion 13 to squeeze the head portion 31 of the locking unit 30 into the inner recessed slot 131 of the massaging unit 10, and the screw 33 can be inserted into the fixed hole 22 of the connecting unit 20 to secure the massaging unit 10 and the connecting unit 20. The cover 34 can be pressed into the fixed hole 22 of the connecting unit 20 to finish the assembly process. According to the structure stated above, the connecting unit 20 can be coupled with various massaging units 10 with different sizes, and the positioning slot 23 can be used to quickly assemble and disassemble the massaging unit 10.

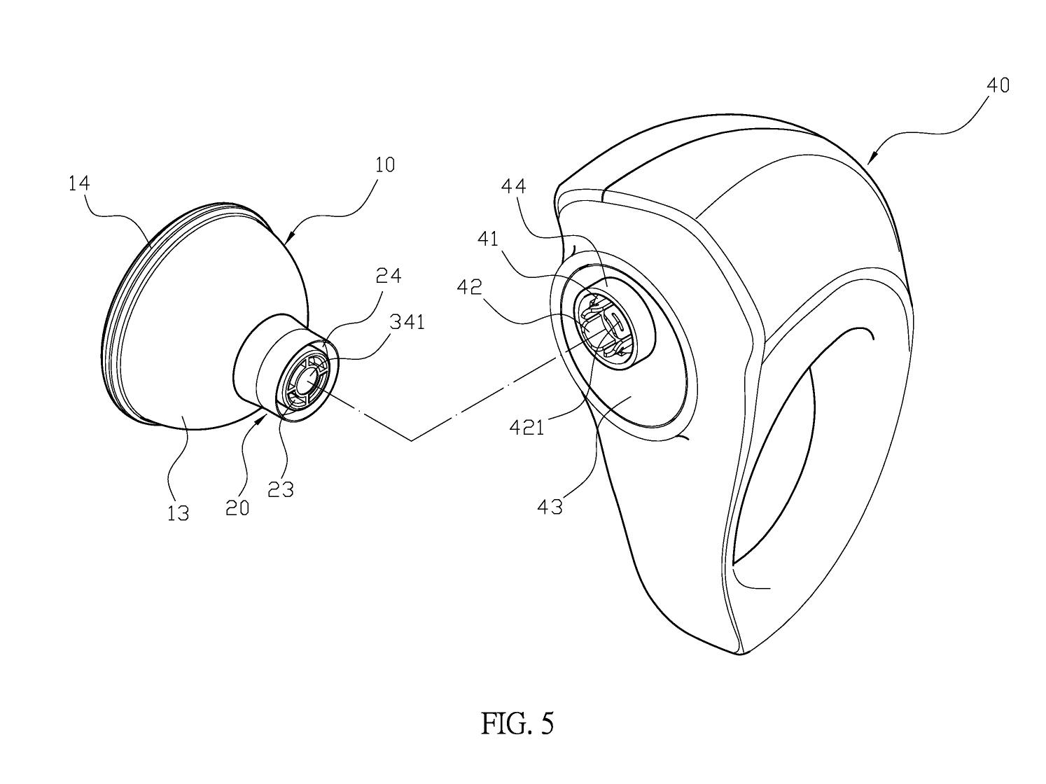

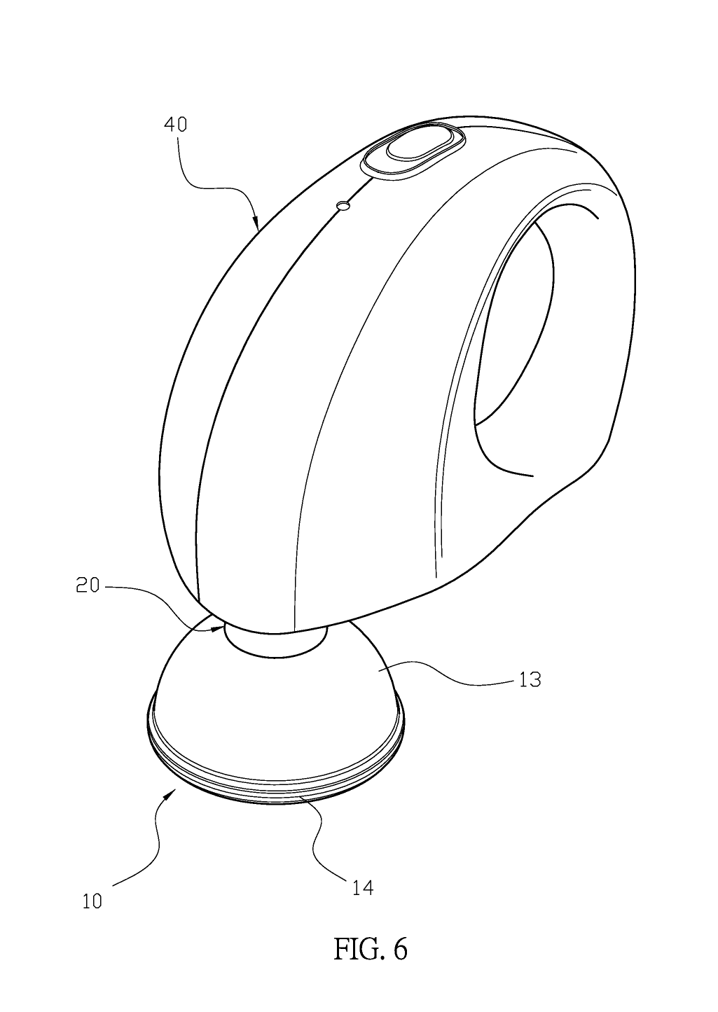

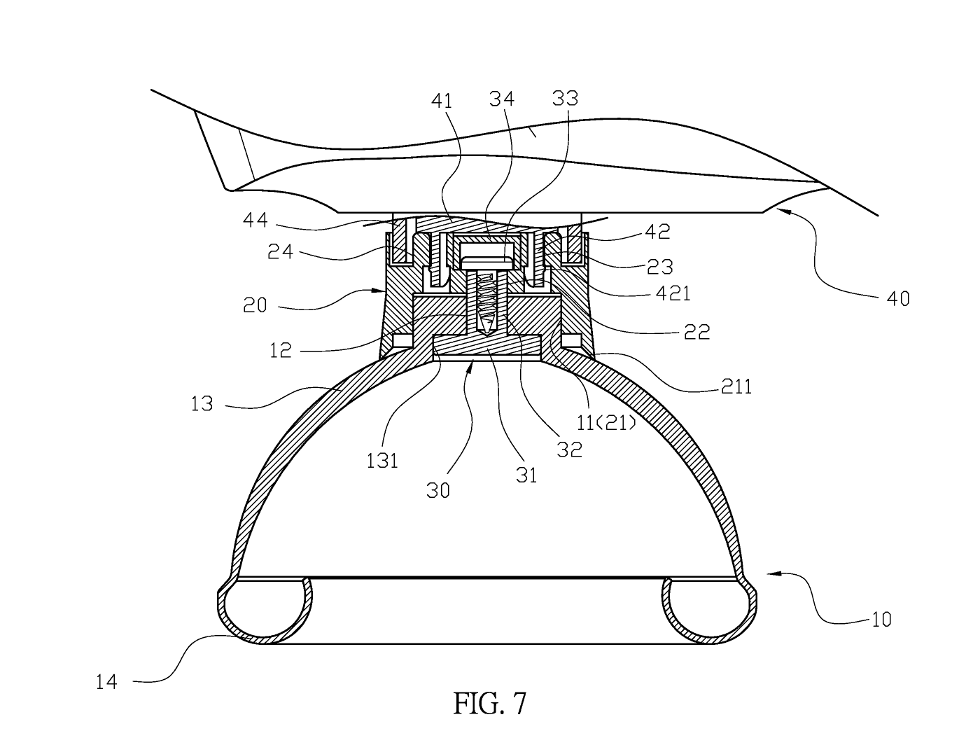

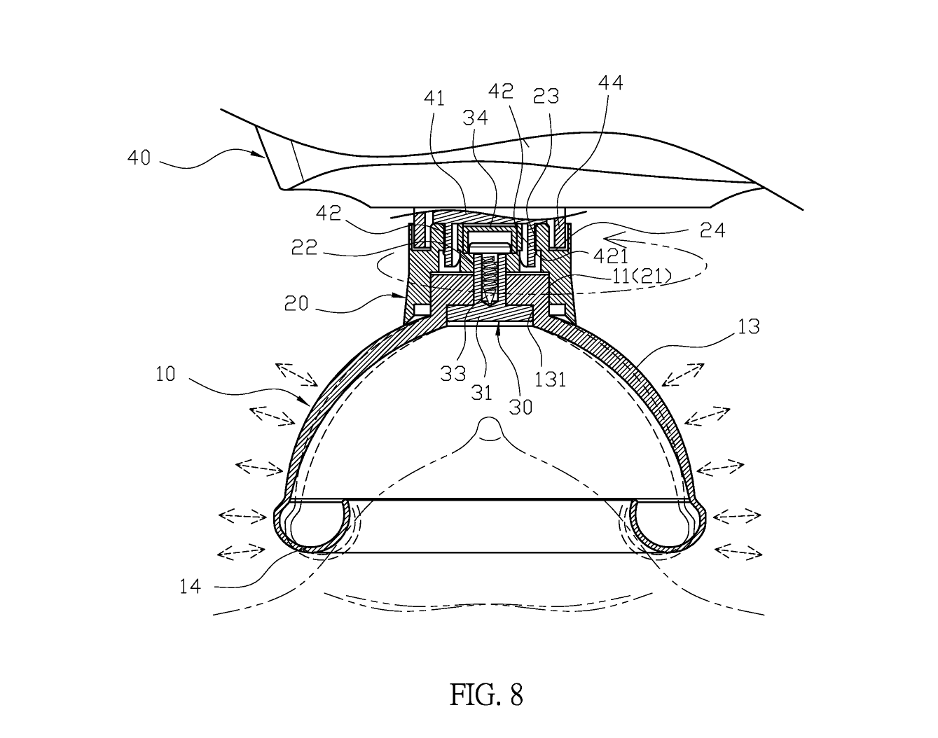

When in use, referring to FIGS. 5 to 8, the present invention further includes a driving device 40 having a rotating shaft 41, and rear end of the rotating shaft 41 has a plurality of positioning pieces 42, and a stopping block 421 is protrudingly formed at outer surface of the positioning piece 42. The positioning piece 42 of the driving device 40 is used to plug into the positioning slot 23 of the connecting unit 20, and the stopping block 421 is received by the receiving space 21 of the connecting unit 20 to quickly engage the driving device 40 and the massaging unit 10. When the massaging unit 10 needs to be replaced, the connecting unit 20 can be pulled to cause the positioning piece 42 to shrink inwardly, so the massaging unit 10 can be easily replaced. Also, a ring slot 24 is recessedly formed at outer periphery of the positioning slot 23 of the connecting unit 20 and a restricting ring 44 is protrudingly formed at outer periphery of the rotating shaft 41 at a eccentric plate 43. The restricting ring 44 is configured to plug into the ring slot 24 of the connecting unit 20 to prevent the connecting unit 20 from overly bending the positioning piece 42. The rotating shaft 41 of the driving device 40 is disposed at the eccentric plate 43 that is driven to rotate by the driving device 40, and the rotating shaft 41 is circularly rotated to enhance the massaging effect. The elastic ring 14 of the massaging unit 10 is used to cover the user's body and with the elasticity of the elastic ring 14, the massaging unit 10 contact the user's body in a planar manner to eliminate the discomfort during the massaging process. Also, when the driving device 40 is turned on, the rotating shaft 41 and the eccentric plate 43 are rotating eccentrically. The positioning piece 42 of the rotating shaft 41 is configured to link the positioning slot 23 of the connecting unit 20 to generate massaging effect at the bowl-shaped portion 13 and the elastic ring 14 of the massaging unit 10. The present invention can achieve another goal of waterproof because the massaging unit 10 and the connecting unit 20 are secured by the locking unit 30. More specifically, the head portion 31 of the locking unit 30 is squeezed into the inner recessed slot 131 of the massaging unit 10 and the waterproof effect between the massaging unit 10 and the locking unit 30 can be resulted due to the elasticity of the bowl-shaped portion 13. So, the massaging unit can be used when the essential oils are on the user's body and the user does not have to worry that the essential oils may leak into the connecting unit 20 or driving device 40.

According to the embodiments described above, the present invention has the following advantages: (i) one end of the connecting unit 20 has a receiving space 21 that is used to receive the protruding block 11 of the massaging unit 10, and the connecting unit 20 has a fixed hole 22 aligned with the through hole 12, and a plurality of positioning slots 23 are circularly formed at outer periphery of the fixed hole 22 of the connecting unit 20; the positioning piece 42 of the driving device 40 is used to plug into the positioning slot 23 of the connecting unit 20, and the stopping block 421 is received by the receiving space 21 of the connecting unit 20 to quickly engage the driving device 40 and the massaging unit 10; (ii) the receiving space 21 that is used to receive the protruding block 11 of the massaging unit 10, and the connecting unit 20 has a fixed hole 22 aligned with the through hole 12, so that the head portion 31 of the locking unit 30 can be squeezed into the inner recessed slot 131 of the massaging unit 10, and the screw 33 can be inserted into the fixed hole 22 of the connecting unit 20 to secure the massaging unit 10 and the connecting unit 20, and prevent the massaging unit 10 and the connecting unit 20 from falling off; and (iii) the ring slot 24 is recessedly formed at outer periphery of the positioning slot 23 of the connecting unit 20 and a restricting ring 44 is protrudingly formed at outer periphery of the rotating shaft 41 at a eccentric plate 43; the restricting ring 44 is configured to plug into the ring slot 24 of the connecting unit 20 to prevent the connecting unit 20 from overly bending the positioning piece 42.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A positioning structure of a plastic disk in a massaging device comprising:
a massaging unit having a protruding block that has a through hole;
a connecting unit, one end of which having a receiving space that is used to receive the protruding block, a fixed hole of the connecting unit aligned with the through hole, and a plurality of positioning slots circularly formed at outer periphery of the fixed hole of the connecting unit; and
a locking unit having a head portion and a tubular unit extending from the head portion, wherein the tubular unit of the locking unit passes through the through hole and fixed hole, and a screw is used to secure the tubular unit to connect the massaging unit and the connecting unit.

2. The positioning structure of a plastic disk in a massaging device further comprising a driving device having a rotating shaft, and rear end of the rotating shaft having a plurality of positioning pieces, and a stopping block is protrudingly formed at outer surface of the positioning piece, wherein the positioning piece of the driving device is used to plug into the positioning slot of the connecting unit, and the stopping block is received by the receiving space of the connecting unit to quickly engage the driving device and the massaging unit.

3. The positioning structure of a plastic disk in a massaging device of claim 2, wherein the rotating shaft of the driving device is disposed at an eccentric plate that is driven to rotate by the driving device.

4. The positioning structure of a plastic disk in a massaging device of claim 3, wherein a ring slot is recessedly formed at outer periphery of the positioning slot of the connecting unit and a restricting ring is protrudingly formed at outer periphery of the rotating shaft at a eccentric plate, and the restricting ring is configured to plug into the ring slot of the connecting unit to prevent the connecting unit from overly bending the positioning piece.

5. The positioning structure of a plastic disk in a massaging device of claim 1, wherein the connecting unit has a cover near the fixed hole, and top portion of the cover has a flat portion to cover the opening of the fixed hole to protect the screw therein.

6. The positioning structure of a plastic disk in a massaging device of claim 1, wherein a bowl-shaped portion is formed at one end of the protruding block and an elastic ring is formed at an enlarging end of the bowl-shaped portion.

7. The positioning structure of a plastic disk in a massaging device of claim 6, wherein the bowl-shaped portion of the massaging unit has various sizes used to secure the connecting unit at the protruding block to achieve the goal of quick replacement and connection.

8. The positioning structure of a plastic disk in a massaging device of claim 6, wherein a plurality of protruding elements are formed on the surface of the elastic ring to enhance the massaging effect.

9. The positioning structure of a plastic disk in a massaging device of claim 6, wherein an inner recessed slot is formed at outer periphery of the through hole of the bowl-shaped portion, and the head portion of the locking unit is configured to be received in the inner recessed slot of the massaging unit to form a elastic compression to achieve an anti-leaking effect between the massaging unit and the locking unit.

10. The positioning structure of a plastic disk in a massaging device of claim 1, wherein a guiding inclined surface is formed inside the receiving space of the connecting unit and the guiding inclined surface is used to tightly attach with the massaging unit.
